(19) United States
(12) Patent Application Publication
(10) Pub. No.: US 2007/0247276 A1
(43) Pub. Date: Oct. 25, 2007

(54) Electronic or automatic identification method to remotely manage a lock or access point to a secure distribution receptacle, via the Internet or wireless communication network

(76) Inventors: Kenneth Murchison, Dallas, TX (US); W.C. Chip Perryman, Athens, TX (US)

Correspondence Address: JACKSON WALKER LLP, 901 MAIN STREET, SUITE 6000, DALLAS, TX, 75202-3797, US

(21) Appl. No.: 11/703,576

(22) Filed: Feb. 7, 2007

Related U.S. Application Data
(63) Continuation-in-part of application No. 11/409,606, filed on Apr. 24, 2006.

(51) Int. Cl. H04L 9/14

(52) U.S. Cl. 340/5.2

(57) ABSTRACT

A secure delivery appliance with a locking mechanism that is electronically managed or hosted at a remote central location via the Internet or wireless communication network with conditional code validations. Remote management Portal software resides on host computer servers, which are in turn accessed and managed by user members through a common browser interface via the Internet or a wireless communication network via a wireless mobile device. The remote host portal software provides a variety of robust options for the user of the local access point, to program multiple access codes with varying conditions of time, date and use occurrence limitations. Additionally, the host software provides information, distributes codes, tracks and reports usage events at the respective local access points. The host interfaces with each unique local electronic locking mechanism at the respective local access location either via a web enabled device or a common PC based Internet browser or wireless mobile device.

### CLAIM OF PRIORITY

This application claims priority of and is a Continuation-in-part of U.S. patent application Ser. No. 11/409,606, filed Apr. 24, 2006 entitled “A REMOTELY MANAGED LOCK OR ACCESS POINT, VIA THE INTERNET, TO A DISTRIBUTION RECEPTACLE OR SECURE LOCATION”.

### FIELD OF THE INVENTION

The present invention is related to providing controlled access to an access point.

### BACKGROUND OF THE INVENTION

U.S. Pat. No. 5,774,053 to Porter which is hereby incorporated by reference describes a storage device for the delivery and pickup of goods. As recognized in that disclosure, home delivery of goods has become more and more popular with the rise of shopping over the Internet, by mail-order, and by local merchants. In addition to clothing, appliances, furniture, books and other materials previously available from catalogs and the like, the Internet has spawned e-shopping services for groceries and other items. Similarly, in many areas, local merchants such as dry cleaners offer residential pickup and delivery services for their customers.

The Porter storage device teaches a means for such home pickups and deliveries even when the homeowner was absent. The storage device provides a secure environment for the goods and included a communication apparatus for providing notification that the goods had been picked up or delivered. Access to the storage device may be gained by entering a so-called vendor code into a controller via a keypad. The controller oversees locking/unlocking of the storage device. Entering a valid vendor code unlocks the storage device, allowing couriers and/or others to pickup and/or deliver goods from/to the storage device.

One shortcoming with the storage device described by U.S. Pat. No. 5,774,053 concerns the use of the vendor codes. As contemplated, the vendor codes are static, reusable codes assigned to each vendor that delivers and/or picks up goods to/from the storage device. For example, a laundry and dry cleaning business may be assigned a vendor code of 333, whereas a local grocery store may be assigned a vendor code of 444. The use of such vendor codes may present a security risk in that once an unauthorized person learns one of the codes, that individual has access to the storage device until such time as the code is removed from the list of authorized vendor codes stored in the controller's memory. This may present a problem inasmuch as several days or weeks may pass before a storage box owner learns that one or more of the vendor codes has been compromised and has time to reprogram the controller with new vendor codes. During this time, the security of the storage box is questionable at best. Moreover, the assigning, cancelling and reassigning of the vendor codes requires what could be a significant amount of time and effort (key management) on the part of a storage device owner/end-user. Also, the vendors are required to keep track of codes for different customers and, presumably, must take steps to ensure that the security of these codes is maintained.

A further shortcoming with the Porter storage device described in U.S. Pat. No. 5,774,053 concerns the necessity for delivery persons to keep a record of access codes and to manually enter such vendor codes. This is problematic in that some delivery services, particularly the United States Postal Service (“USPS”), prohibit deliveries to a receptacle which requires a key or manual code for access. Such manual keys and codes are wrought with wasted time and data entry errors which negatively impact the number of deliveries per hour, a metric which is closely monitored by delivery companies.

### SUMMARY OF INVENTION

The present invention achieves technical advantages as a device and system configured to utilize a manual electronic keypad or electronic Auto-ID and remotely manage an access point to a distribution receptacle or a Secure Delivery Appliance (the “Device”). This invention allows many users or Members to provide access to many delivery Providers (“Provider”) to a single secure Delivery Appliance. The system further provides robust management and communication of authorized codes and tracking and reporting activity at the secure delivery appliance. The present invention may include an electronic keypad or automatic identification method (“Auto-ID”) utilizing radio frequency identification (“RFID”), bar codes, smart cards, optical character recognition (“OCR”), and biometric technologies (voice recognition, fingerprint or retinal scans, for instance), for communicating access codes to a controlled access point of a delivery and storage receptacle and locked access point thereof and further, remotely managing the validity of and tracking and reporting the use of such codes.

### BRIEF DESCRIPTION OF THE DRAWINGS

FIG. 1 depicts a block diagram and architecture of the invention operation;

FIG. 2 depicts a basic design of a sample size of the Secure Delivery Appliance cabinet Device and parts callout according to one preferred embodiment of the invention;

FIGS. 3A, 3B and 3C depict additional views of the internal layout of a sample size of the Secure Delivery Appliance cabinet Device; and

FIG. 4 depicts the functionality flow chart for the Device.

### DETAILED DESCRIPTION OF THE PRESENT INVENTION

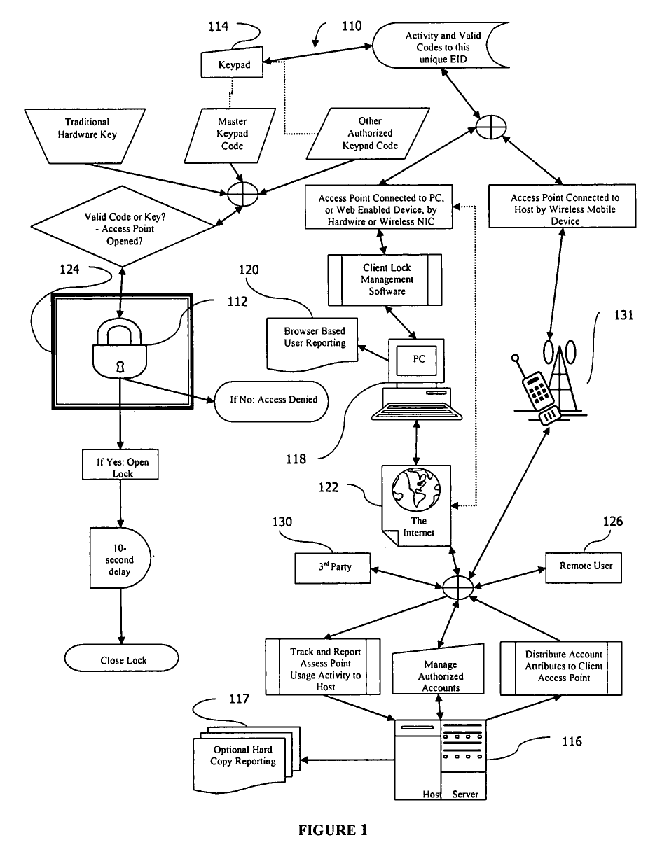

Referring now to FIG. 1, there is generally shown at 110 an overview of the present invention and environment for using same. System 110 is seen to include a controlled Delivery Appliance access point 112 and a physically remote Host Server 116 for facilitating controlling the access thereof from a physically remote location. A data entry module 114 that is at, or physically remote from, the access point 112 and Host 116 may be used to gain access to access point 112, and may be a keypad, card reader, wireless mobile device, RFID receiver, biometric sensor such as a finger print reader, or other mechanism for authenticating some type of electronic code to allow access to the access point 112. Host 116 in this embodiment is electronically coupled to access point 112 via the internet or a wireless communication network to control the configuration of access point 112, such as to provide electronic codes thereat which are valid codes for permitting access at access point 112. These codes can be established and have a plurality of parameters, such that they are valid according to both fixed and selectable parameters. For instance, some codes may be valid all the time, while others may be valid during certain times of the day, on certain days, or certain weeks, or even temporary codes. Such temporary codes may be provided to different vendors, such as pizza delivery services, swimming pool services, friends, visitors and so forth which will be described in more detail shortly.

One of the advantageous features of this system 110 is that verifications and reports can be generated, to create logs, for instance, of Events at the Delivery Appliance access point 112, attempted access, and as a function of keys entered, attempted keys used, and also to receive confirmations when such access was granted or denied, generally shown at 117. These reports can be stored at the Host 116 or locally at the access point, but also can be sent, or remotely accessed. The alerts can be provided to Members, including the Master Member of system 110, and Providers, via the internet as a message deliverable to a party, such as the Delivery Appliance owner, a delivery service Provider, a security monitoring agency, and so forth. Such messages may be sent as an email, an SMS text message and so forth to a computer, personal digital assistant (PDA), phone, wireless mobile device or other communication module. Such reported activity could include the code used, time, date, location, audio, video or other recorded multimedia data. Locally, the access point 112 may be controlled by a resident communication module 118 on site, or proximate the access point 112, which communication module 118 electronically communicates via a communication link with the remote Host server 116, such as via the internet or a wireless communication network, such as via a wireless mobile device 131. Reports of Events, or attempted access, can be generated by the local communication terminal 118 as generally shown at 120.

Still referring now to FIG. 1, this embodiment of the invention is shown as an unattended, built in, secure delivery and storage appliance for the home or business, generally shown at 124. The appliance 124 combines a weatherproof and theft resistant built-in cabinet that is accessed by the electronic input module 114, such as a Keypad or other electronic communication Device operated locking mechanism. The Keypad 114 accommodates multiple access codes that are programmed either manually at the Keypad, or managed remotely over the internet 122 by the Member via an Internet based interface to the Host server Portal 116, or by a wireless communication network via a wireless mobile device 131 to the Host server 116.

The cabinet 124 may generally resemble a night depository box customarily seen at a bank or library. It may be fabricated out of heavy gauge welded steel, sheet metal, ABS plastic or other suitable material. It may customarily be built-in to new construction as an attachment to the exterior wall of the home or business. It may, however, be just as suitable for retrofitting into existing construction or installed as a freestanding unit at the curb in a similar manner as a mailbox. The cabinet may have a single secure exterior access door, or double doors: a secure door on the exterior wall of the building and an unsecured or optional secure door on the interior wall of the building. The building occupant may typically install it at a height that is convenient for the delivery Provider and retrieval by the Member. In some applications, heated, cooled or other environmentally controlled cabinets may be employed. The Delivery Appliance cabinet may also be a freestanding unit that would resemble a U.S. Mail or FedEx deposit box.

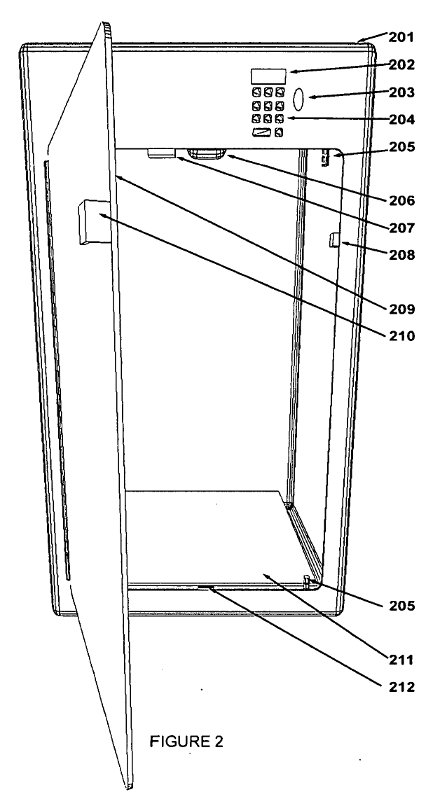

Referring now to FIG. 2, there is shown another preferred embodiment of the invention. In this embodiment of the invention, a system including a remote Host server, which is accessed by a Member via the Internet or by a wireless communication network, is configured to manage access codes for an associated locking mechanism at a secure delivery appliance (or “Device”). The Host may also track and report use at the access point whether it is secure or unsecured. The user (“Member”), being a homeowner, business owner, property manager or security personnel, for instance, utilizes the system.

The general design of the Secure Delivery Appliance is relatively straightforward. It may consist of a receptacle or cabinet of suitable size. The door may be locked and unlocked with a standard solenoid latch. A set of contact switches indicate door and package status.

The cabinet incorporates a control and communications module (“Module”) that manages access and notification. This Module is also the host to which other sensors are attached, such as RFID, barcode and biometric reader. The Module incorporates network communications capability, key pad input (Numeric standard), small screen output (1 line 20-40 characters), electronic lock, and is expandable to incorporate a RFID receiver, barcode scanner, and or a wireless communication Device.

The control Module incorporates a small CPU capable of handling the secure communications needs of the invention. This CPU may manage both remote and local user interactions as well as the physical access to items in the box.

A low powered microcontroller is incorporated into the Module. This microcontroller provides 10/100Base-T Ethernet Connectivity, a suitable amount of Flash or SRAM standard electronic memory, digital protected inputs, high-current digital outputs, serial ports, and a backup battery for RTC (time/date clock).

The digital inputs allow a set of simple pinch switches to tell the CPU whether the door is open or closed and if there is something inside the compartment. This enables remote delivery detection even without a tracking number.

The digital output allows the CPU to provide voltage to a solenoid in order to retract the door latch and allow the door to open. From an engineering standpoint the door solenoid is designed to be either locked or unlocked in its un-powered state. Security considerations suggest that the door should remain locked when power fails to prevent unauthorized access. The total power draw is sufficiently low such that a small onboard battery can provide extended operations without external power.

Serial ports allow Devices such as keypads, RFID-readers, barcode-scanners and alike to be directly addressed by the Module. This allows the Device to be completely modular and contain only the capabilities required for a particular installation. When a barcode scanner is incorporated, the barcode reader has a small window, or punch-out to provide line of sight from the cabinet.

All user access to the Secure Delivery Appliance invention are through a centralized web-based portal, using any standard Internet browser or wireless communication network Device. Registered Members and Providers may perform three primary tasks on the portal as follows.

1. Account Management—Accounts for the invention are configured for a single Device that can be shared by multiple individuals within an entity. The entity can be a single user, multiple users within a household, or multiple business users sharing the same Device. Each individual in the entity is called a member (“Member”), and has a separate login and password. One Member is designated as the Master Member. This individual Member can create, edit, or remove any additional Members associated with the entity account.

In this design, a one-to-one relationship exists between the entity and the Device, and that entity may be responsible for use of the single Device. The system may also include support for single entity—multiple Devices (to support standardized account management for multiple locations) and support for single entity—multiple Member management (to support environments where a single Device is shared by multiple Members (for example, in a multi-family apartment or office suite environment).

The entity relationship allows a Master Member to manage all aspects of the account while letting other entity Members create and manage delivery Events (“Event”) (such as a one-time access for pizza delivery).

The primary tasks available under Account Management are:

A. View Other Members in this entity—only available to the Master Member.

B. Add, edit, or delete Members in this entity—only available to Master Member.

C. Add or edit individual Member profile, to update email, phone, etc.—available to all Members in the entity.

D. View billing and payment details for all Members in this entity—only available to Master Member.

E. Pay bill online for this entity—only available to Master Member.

F. Schedule Device communication frequency, which determines how often the Device will be updated from host servers—only available to Master Member.

2. Provider Management—Members typically have many recurring Events using the same Provider, such as UPS or FedEx. Under Provider management, Members may create configuration profiles for recurring Providers, which may then be associated with single-or-multiple frequency Events.

A. System Providers—Many Provider configurations are common to all Members, differing only by the account number and login information necessary to access an individual account. For example, a Member may use UPS on a regular basis. The invention utilizes established web services published by UPS (and other Providers) to access package tracking information for specific Members. The same set of UPS web services can be used by all Members, varying only by individual login information for each user. These Providers are known as “System Providers”.

Once the Member adds UPS to his list of Member Providers, the invention's host system only needs to know the Member account information for that Provider. All other details about the Provider are already known and managed in a host system configuration file.

B. Member-Defined Provider configurations—Other Providers do not have standard configurations, as they may be local to the Member and not have automated access methods. For example, a favorite dry cleaner or delivery service can be set up as a Member-specific Provider. The host system doesn't have any pre-established method for communicating with this Provider, so it is defined by the Member. The Member may want to create a recurring access code and schedule for this Provider, which can be used on an on-going basis by the Provider until modified or disabled by the Member.

C. Provider Frequency and Restrictions—Members are able to define default frequency and restrictions for each Provider. Members may choose to only allow Providers to access the Device during the work week, or may only allow four separate access Events. Each of these may be overridden on an Event-by-Event basis.

3. Event Management—Each use of the Device is an Event. Events can be one-time or recurring, and limited or unlimited in terms of duration, frequency, and date, or time. Each Event is associated with a Provider. Members can create Events and Providers on-the-fly (for one-time Events with infrequently used Providers), or may schedule recurring Events for frequent Providers.

The number and frequency of Events is unlimited, and the behavior of each Event can be different from one Provider to the next, or can be different for the same Provider with multiple Events.

### EXAMPLES OF EVENTS

1. UPS Package Delivery—UPS is setup using the host System Provider configuration. The UPS configuration can store the Member's UPS account information, so when the Member logs into the host Portal, any UPS shipments can be tracked through the Member portal at all times using the UPS web service.

Members are able to create new delivery Events simply by clicking on the tracking number of the shipment. The new Event can use the tracking number as the default access code for the Device, and be configured with any variety of access restrictions or delivery frequency. Most likely, the Event may be configured for one-time use using the UPS tracking number. UPS may attempt to deliver the package to the Member's Device using the UPS tracking number as the Device's authorized access code, which may be keyed in, scanned by bar code, or read by an RFID tag. Once the package is delivered, the Device inactivates that access code for further use.

2. Dry Cleaning Delivery—Bob's Dry Cleaners is setup using the Member's configuration. Bob's does not have a web service or other automated order management system, so the Member creates a recurring access code for Bob's, with a frequency of once a week, and time restriction limiting access between 8:00 a.m. and 5:00 p.m. Monday through Friday.

Bob's Dry Cleaners can drop off cleaning on an on-going basis, subject to the frequency and time restrictions initially configured. The Member can retain this Event indefinitely, or set an expiration date beyond which the Event is inactive.

3. Pizza Delivery—A Member creates a one-time Event for Speedy Luigi's—a local pizza delivery. The Member creates a unique access code for this delivery, which may only run once, and expire by 10:00 p.m. that evening.

Member Accounts are configured by a Master Member for a single Device, or a plurality of Devices, that can be shared by multiple individuals within an entity. The entity can be a single user, multiple users within a household, or multiple business users sharing the same Device. Each individual in the entity is called a Member, and has a separate login and password. One Member is designated as the Master Member. This individual Member can create, edit, or remove any additional Members associated with the entity account.

The entity relationship allows a Master Member to manage all security and financial aspects of the account while letting other entity Members create and manage delivery Events (such as a one-time access for pizza delivery). The primary tasks available under Account Management may be:

View Other Members in this entity—only available to the Master Member

Add, edit, or delete Members in this entity—only available to Master Member

Add or edit individual Member profile, to update email, phone, etc.—available to all Members in the entity.

View billing and payment details for all Members in this entity—only available to Master Member.

Pay bill online for this entity—only available to Master Member.

Schedule Device communication frequency, which determines how often Device will be updated from host servers—only available to Master Member.

The Member may create a single or multiple authorized codes and assign applicable time, date and recurrence limitations to each. The Host server issues to a Provider, a merchant or delivery service (“Provider”), valid access codes for the locking mechanism, wherein the access codes are issued from a list of currently valid codes for a respective locking mechanism. The Provider enters the authorized code at the access point and the locking mechanism is actuated to open. The control unit at the locking mechanism in turn reports back electronically to the Host server all Events at the access point or keypad. Such Event could include the code used, time, date, location, audio, video or other recorded multimedia data. This Event is tracked and logged by the Host, which is in turn reported back to the Member. The 3^{rd} party Provider may also receive a log of the Event activity limited to their usage.

Each individual Device needs to communicate periodically with the host servers to download new access information and check for updates. The Device communication schedule can be configured by the Member, so that the Device can contact the host on a weekly or daily schedule for access updates.

Since Members can create new Events or modify existing Events on the host at any time, the Device should always attempt to contact the host whenever access is attempted. The on-demand nature of the portal requires the Device to confirm all access requests at the time access is attempted.

Given the asynchronous nature of the Internet and the wireless communication network, it is impractical to assume that the Device will always be able to communicate with the host. At such times, the Device may be configured to use the most recently downloaded information to validate access. Members are able to over-ride such access on an Event-by-Event basis, so that in case of a communications failure the Member could specify that no access validation will occur for specific Events (security access), or allow access for other types of Events (pizza delivery).

To ensure high system availability, the Device does not need to download a complete set of Event data with each access. Instead, the host maintains an update bit value for each Member account—the Device only needs to download new data if the bit value had changed since the last download.

The Device incorporates a standard Ethernet interface for Internet communications or a wireless communication network Device, and supports the use of industry-standard XML document formats. When an access Event is initiated (someone tries to open the Device using valid interfaces), the Device transmits an encrypted XML document containing all required validation data to a web service at the host system. The host system decrypts the XML document, and compares the validation data to the Member's Event profile. Based on this comparison, the host sends an encrypted confirmation or denial of the request, which causes the Device to either accept or reject the access Event.

As discussed elsewhere in this application, the portal may utilize a variety of web services published by Providers such as UPS and FedEx to integrate with these 3^{rd} party System Providers. These web services are typically free, but the portal needs to incorporate the necessary functionality to access these services. Each Provider offering a web service (or other means of automated order/shipment tracking) is added to the list of System Provider configurations available to all Members.

The physical lock may be actuated via an electronic keypad that is either programmed manually at the keypad or managed remotely to a hosted Portal via an interface over the Internet or a wireless communication network. The Portal interface to the locking mechanism offers a great deal of flexibility. Through the Portal, the authorized Member is able to assign multiple valid access codes that can be limited to certain authorized delivery persons, or Providers, of varying durations, or one time use that might be limited to a particular delivery. In this way, a Member can allow access to the Device from a remote location using an Internet based or wireless communication network interface. The keypad may also accommodate traditional hardware key to access the locking mechanism in the event of a power failure. The keypad may also be manually programmed to accommodate a Master Member's digital code, thus mitigating the need for an Internet connection, a wireless communication network signal, or a lost hardware key.

Each Device may incorporate a unique electronic identification number (“EID”) assigned to each locking Device. This EID enables the Host server to manage secure code authorizations associated with that Device EID and access to each respective locking Device. The Host also manages reporting and/or billing to the Member. It tracks each occurrence of an Event or change of a code as well as the time and any other relevant data associated with each Event. Additionally the Host may track each unauthenticated attempt to access the Device. The Member is able to both manage access codes as well as track all Event activity at the Device. Events may be tracked either through a browser based interface to the management system database Portal, by electronic data interchange (“EDI”), by a wireless communication network or by periodic hard copy printout provided by the Host system manager to the Member.

The Member may additionally have the ability to assign a valid access code with its associated restrictions that is valid on a plurality of Devices. This may be applicable in an apartment building with 150 tenants wherein the building superintendent needs access to all Devices with a single valid access code.

The Portal may be managed or hosted at a central location. It may reside on computer servers and interface with each unique Device through the Internet or a wireless communication network to the remote location. At the local access point, a web enabled Device, a wireless mobile device or client software provides a connection between the Host Portal and the access point. The connection to the access point may be either via a hardwired connection, such as a CAT-5 cable, from the local Internet connection to the Device controller or by a wireless Device such as a common wireless NIC, or by a wireless mobile device. Security such as secure socket layer (SSL), public key/private key encryption can be incorporated into the Host server, local client software, web enabled Device, wireless mobile device or keypad controller.

Referring now to FIG. 2, there is generally shown one preferred embodiment of the appliance 124 shown as a Secure delivery Appliance cabinet 201 with a hinged access door (209). The overall dimensions of this illustrated cabinet are configured for a typical application but could be of varying dimensions depending upon the respective application. The cabinet (201) shown is a free standing unit, but the invention could also be configured as a built-in version installable in a wall of a structure, such as a home or other building.

An I/O panel and CPU box keypad (204) and Module defined above. The Module is a built-in microcomputer to which all of the other cabinet components are attached and controlled. Optionally the Module may also contain a display panel (202).

Still referring to FIG. 2, a Top Lock 205 and Bottom Lock 205 are electrically activated solenoids that are actuated to lock or unlock an access door (209), which is equipped with a handle (210).

A Door Sensor (208) in FIG. 2 is an electronic switch configured to detect the status of the cabinet door 209 as being opened or closed, and also creates an electronic Event for each occurrence of a change in opened or closed status.

FIG. 2 also shows a Bar Code Reader (206) and an RFID reader (207) which are connected electronically by ports to the CPU Module. These readers are Auto-ID receivers that read and transmit electronic access codes to the Module. Also shown on FIG. 2, biometric scanners (203) could also be installed, such as a fingerprint reader.

Additionally, FIG. 2 shows a False Floor (211) configured as a Package Sensor. There is an additional electronic sensor (212) that detects the status of the floor of the cabinet as having an object placed in the cabinet or whether the cabinet is empty. This switch also creates an electronic Event for each occurrence of a change in occupied or empty status of the cabinet.

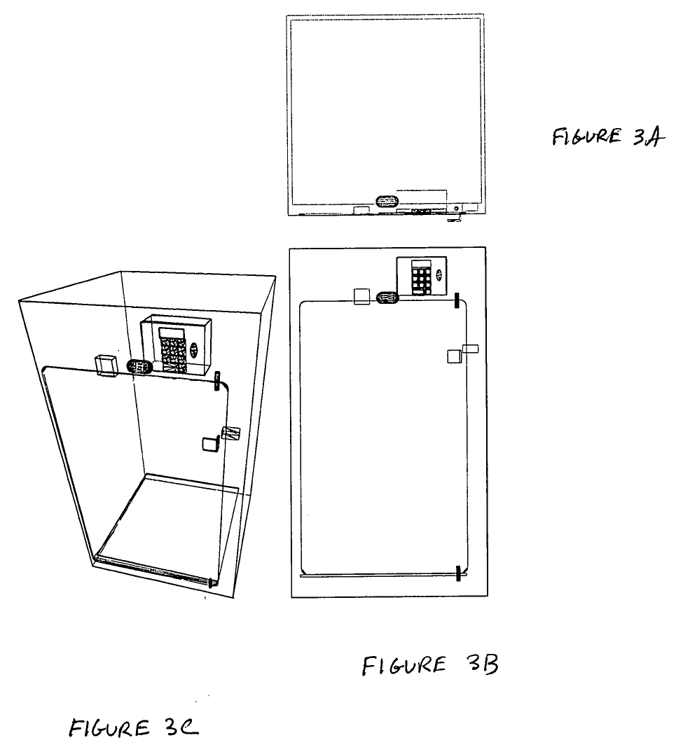

Referring now to FIGS. 3A, 3B and 3C, additional views of the cabinet and the various components are provided.

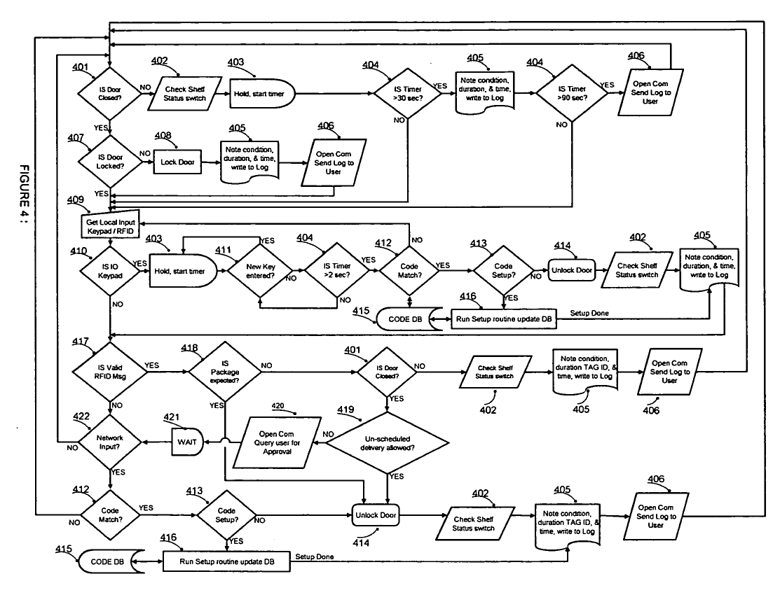

FIG. 4 depicts the functionality flow chart for the cabinet components that are electronically managed by the local CPU Module as opposed to the Member and Provider account activities that are managed by the host server.
401 This step checks a sensor to determine if the door is closed
402 This step checks a sensor to determine if a object is present
403 This step starts an internal timer
404 This step checks to see if a certain amount of time has elapsed
405 This step checks the status of various sensors and other conditions and prepares an electronic log entry.
406 This step opens a suitable communications channel and sends recent log entry(s) to a central server and or directly to an authorized user. This channel could be wired or wireless.
407 This step checks to see if the door is locked.
408 This step locks the door if it not already locked.
409 This allows the CPU step polls external or optional input sources.
410 This step checks for input from the key pad
411 This step checks for continued key input
412 This step checks to see f the entered code matches what is on file
413 This step checks to see if the entered code is a special set up code for changing internal parameters.
414 This step unlocks the door by powering a solenoid or some other suitable means.
415 This step shows access to a code database for security purposes.
416 This step runs through a setup routine allowing parameters to be changes and the database to be updated.
417 This step checks to see if a valid RFID message has been received.
418 This step checks the internal database to see if a package is expected.
419 This step checks the internal database to see if unexpected deliveries will be accepted denied or accepted with outside confirmation.
420 This step opens a connection to an authorized user or database and requests approval for an unscheduled delivery or other action not covered by current operating instructions.
421 This step pauses for a predetermined amount of time to allow a interactive connection with the user to be established and a decision to be made.
422 This step checks for external network input.

The cabinet's size and use is suitable for, but not limited to, the unattended delivery and secure storage of U.S. mail, mail order consumer goods packages, overnight and courier document packages, private delivery packages, home delivery meals, laundry, or home delivery groceries. The size may be large enough to accommodate a typical size box from a mail order company, a delivery of dry cleaning on hangers, a few sacks of groceries, or several large boxes of pizza. One typical interior measurement of the storage area might be 24″ deep×24″ high×24″ wide. The size of the appliance 201 may additionally vary from small units that can only accommodate a few books to very large units that can be as large a several hundred square feet. The User or building occupant may finish the exterior of the storage appliance with paint or a veneer to coordinate with the desired decor. However, the cabinet may also be offered with a factory finish.

Referring now back to FIG. 1, in these secure Delivery Appliance applications, one-time use access codes may be assigned to the delivery Provider like FedEx and UPS drivers to deliver packages. The Host 116 via an Internet browser, EDI, XML, voice messaging, text messaging, wireless mobile device, text messaging, email or any other suitable electronic communication method, may transmit authorized codes and applicable usage information to the delivery Provider. The access code and other relevant messages can be associated with the Provider's tracking number and transmitted electronically to the delivery driver or printed on shipping labels.

Additionally, the secure delivery appliance 124 could be built as a combination of a United States Postal Service (“USPS”) mailbox and a general delivery appliance accessed by other non-USPS delivery persons, as may be authorized by the USPS. This embodiment has one compartment that is accessed only by the USPS postman and another that is accessed by other Providers. In this embodiment, the U.S. Mail is also left in a secure delivery receptacle and is secured by a locking mechanism accessible only by an authorized Provider. This will mitigate the risks of identity theft and other mail theft inherent with nun-secure mail delivery.

For nonrecurring deliveries like pizza, the Member has the ability to remotely create a valid one-time use code at a remote location 126, such as the office, for home delivery and transmit it to the authorized Provider while ordering by telephone, by voice message, text message or email.

There may also be other recurring deliveries such as the paperboy who might be given a code that is valid only on Monday through Saturday from 4:00 pm to 7:00 pm and on Sunday mornings from 5:00 am to 8:00 am with no limit to the duration date.

The delivery Provider can ask the Member to authorize that Provider's own preferred familiar code. For example the paperboy might prefer that all delivery boxes in a given neighborhood be the same code, 1776.

The dry cleaners may be given a code that is valid from 8:00 am to 5:00 pm on weekdays only.

The Member might also leave special tools or chemicals in the Delivery Appliance for the lawn or swimming pool service whose access schedule is every 2^{nd} Thursday between 2:00 pm and 5:00 pm and such access being limited to those times.

A contractor who will be on location for one month may need access to the Delivery Appliance during his time on the job site. His access code can be limited to Monday through Saturday, 7:00 am to 6:00 pm, valid from Nov. 5, 2006 through Dec. 4, 2006.

A cable guy may be scheduled to drop off a new channel receiver box at exactly 1:15 pm on Tuesday Nov. 29, 2006. Of course the Member would need to authorize this one-time code from 3:00 am to 11:00 pm on the 28^{th}, 29^{th} and 30^{th}.

### Business Owners of the Delivery Appliance

A Master Member could be a business owner of a secure Delivery Appliance who wished to give employees access. Employee Members can each be given unique codes that are limited to their respective work hours and durations of the job.

Employee Members could be assigned unique codes that that are valid only during their respective working hours. These codes could have indefinite durations and could be suspended or deleted when that employee is on vacation or terminated. The Host system 116 usage reports 117 and 120 could also serve as a substitute for a time clock for verification of employee tardiness or absenteeism.

Similar groups of employees could all be given access codes in a series. For example, all Members of the machinist union could be given codes that begin with 8600-****. If for some reason a Master Member had to suspend all 700 of them all at once, this is easily done with the user interface to the host Portal.

### Problem Solved

### Value Proposition to the Member

The Member (user) of the remotely managed locking Delivery Appliance may be given the ability to have a wide range of robust day, date, time, recurrence and duration authorization options for multiple access codes.
a. The Member can assign an unlimited number of codes. These codes are essentially numeric passwords that can be any length of characters the Member desires.
b. The Member can assign an authorized code that is valid on a plurality of Delivery Appliances.
c. The host system can optionally assign randomly generated access codes like a “quick pick” if the Member wants this convenience.
d. Each code or group of codes can have varying time durations of validity. For example one day, week, month or year starting from the time of first use regardless of when that first use occurs.
e. Each code or group of codes can have finite date and time durations of validity. For example from exactly 7:15 am on the 10, Sep. 2006 to exactly 12:00 midnight on Oct. 15, 2006.
f. Each code or group of codes can have varying time periods of indefinite validity. For example from 9:00 am to 5:00 pm on weekdays only with no ending date.
g. Each code or group of codes can have a varying number of recurrences to authorized use. This could be limited to a one-time only use or for example to exactly 52 uses.
h. Each code or group of codes can have recurrences of authorized use to varying days, weeks, months, or years. For example, every Tuesday, every 3^{rd} Monday of the month, every 15^{th} of month, or every February the 14^{th}.
i. Any code or group of codes can easily be modified, suspended or deleted by the Member. For example when an employee is on vacation, is terminated, when a contractor is finished with his work or an authorized resident moves.

For the homeowner, business owner, property manager or security personnel (“Member”), applications with the secure delivery appliance provide a solution to the need to receive unattended deliveries via a weatherproof and secure storage cabinet.

For the Member, each access to the Device by a delivery Provider is an independent Event, therefore there is no limit to the number of times the Device can be accessed without the need for the owner physically reset the lock. This will allow for multiple deliveries to the Device without the need for the owner physically reset the lock.

The Member and Provider of the secure delivery appliance 12 may be given a solution to unattended “signature required” deliveries. The use of an authorized code by a Provider will be an acceptable substitute for proof of delivery and may provide notification and a tracking mechanism for the time of delivery.

The Member can manage access remotely 126 via the Internet through a common browser interface, or by a wireless communication network via mobile device 131 to the host system Portal 116. In this way, the Member can grant access from a remote office 126, while on vacation, or with a mobile telephone.

The Member and Provider 130 may be given a reporting mechanism to track use Events and delivery times that also offers instant notification to Members and/or Providers via the internet or a wireless communication network via a wireless mobile device. This Event reporting capability could include the code used, time, date, location, audio, video or other recorded multimedia data and is applicable whether the access point 112 is a locked mechanism or is not locked.

Members will typically have many recurring Events using the same Provider, such as UPS or FedEx. Under Provider Management, Members can create configuration profiles for recurring Providers, which may then be associated with single-or-multiple frequency Events.

Many Provider configurations will be common to all Members, differing only by the account number and login information necessary to access an individual account. For example, a Member may use UPS on a regular basis. The invention will utilize established web services published by Providers such as UPS to access package tracking information for specific Members. The same set of Provider web services can be used by all Members, varying only by individual login information for each user. These Providers that are common to many user Members are called “System Providers”.

Once the Member adds a System Provider to his list of Member Providers, the host system only needs to know the Member account information for that Provider. All other details about the Provider are already known and managed in a system configuration file.

Other Providers will not have standard configurations, as they may be local or unique to the Member and not have automated access methods. For example, a favorite dry cleaner or delivery service can be set up as a Member-specific Provider. The invention doesn't have any pre-established method for communicating with this Provider, so it must be defined by the Member. The Member may want to create a recurring access code and schedule for this Provider, which can be used on an on-going basis by the Provider until modified or disabled by the Member. These smaller Providers are known by the system as Member Defined Providers.

### Value Proposition to Providers

Here, the (“Provider”) includes but is not limited to a contractor, employee, invitee, merchant or delivery person, delivery companies such as FedEx, UPS, DHL, U.S. Postal Service, couriers, home delivery groceries, the paper boy, pizza delivery, or dry cleaners. “System Providers” are the large delivery companies that are common to many Members and are known to the system. “Member Defined Providers” are those that are not well known or perhaps unique to the Member.

With the application of the invention as a secure delivery appliance, the Provider will always have a weatherproof and secure place to leave deliveries and will not have the concern of damaged or stolen goods.

The Provider may be given a solution to unattended “signature required” deliveries. As stated above, the use of an authorized code at 14 by a delivery person may be an acceptable substitute for proof of delivery. This may eliminate the occurrences of “no one home” and the resulting undelivered item. The benefit is no wasted delivery time, additional tracking, additional package handling, less after hours payroll at the local shipping service office, and returns to the sender.

System Providers will be able to use their own established communication methods to exchange data with the host system for the invention.

As with some other arrangements, the Provider will not be required to carry a key.

As with some other arrangements, each access Event is an independent Event, therefore there is no limit to the number of times the Device can be accessed without the need for the owner physically reset the lock. This will allow for a second or third, (or unlimited number) delivery Provider to access the Device without being locked out by a previous delivery.

The Host 116 provides a tracking mechanism that will instantly confirm the time of delivery or use of the access point 112.

With widespread acceptance of the invention, Providers will be able to use common EDI text fields for access codes. In the meantime, simple text in the memo field will do. For example, shipping labels may include text such as, “Delivery box access code: 3006”.

The Provider can ask the Member to authorize that Provider's own preferred familiar code. For example the paperboy might prefer that all secure delivery boxes in a given neighborhood be the same code, 1776.

The Member can have a single code that is valid on an unlimited number of access points. Here again, this is applicable to the apartment building superintendent who needs a single valid code to access all of the units in a building.

With the application of Auto-ID, a bar code scanner, magnetic card reader, an RFID receiver or other such electronic receiver on the lock control mechanism, the Provider may not be required to do anything to open the access point. For example, the bar code printed on a package shipping label or the RFID tag on the package could serve as the authorized code.

Further, the Auto-ID authorized access could be granted to the Provider delivery person rather than the package. The barcode or RFID tag could be on the delivery driver's identification badge, thus granting that person appropriate access.

The host system of the invention can integrate with the each respective System Provider's data system to exchange data between the invention's host system and the delivery Provider. In this way, the System Provider, such as FedEx, can provide its own tracking number as the authorized code to the invention's host system.

### Sample Data Tables

The Host System is managed in a relational database architecture. The following Table 1 represents a data sample which tracks usage at each individual access point. Each combination of Device EID and Authorized Access Code will be associated with a unique Member ID#. The access point EID is the unique electronic ID number assigned to each respective access point mechanism. Line 1 of Table 1 illustrates the data captured by the Host system for a single Event or occurrence of a use of the system.

TABLE 1
Table 1 - Global Activity Statement

| Line | Access | | Date | Access |
|---|---|---|---|---|
| # | Point EID | Code used | & Time of Use | Authorized? |
| 1 | 894915 | 10546403 | 3/21/2006 15:09:12 | Yes |
| 2 | 917483 | 11354581 | 3/16/2006 9:52:24 | Yes |
| 3 | 940051 | 1600324 | 3/19/2006 23:18:48 | Yes |
| 4 | 962619 | 18731515 | 3/14/2006 20:48:43 | Yes |
| 5 | 985187 | 18849847 | 3/19/2006 23:18:48 | Yes |
| 6 | 999555 | 3006 | 3/1/2006 15:15:24 | Yes |
| 7 | 999555 | 6345789 | 3/2/2006 14:31:47 | Yes |
| 8 | 999555 | 3006 | 3/2/2006 15:13:54 | Yes |
| 9 | 999555 | 3006 | 3/3/2006 15:14:08 | Yes |
| 10 | 999555 | 3006 | 3/4/2006 15:10:31 | Yes |
| 11 | 999555 | 3006 | 3/5/2006 15:15:22 | Yes |
| 12 | 999555 | 3006 | 3/6/2006 14:00:06 | Yes |
| 13 | 999555 | 3006 | 3/7/2006 14:31:47 | Yes |
| 14 | 999555 | 3006 | 3/8/2006 15:15:58 | Yes |
| 15 | 999555 | 3006 | 3/9/2006 15:15:25 | Yes |
| 16 | 999555 | 222333 | 3/10/2006 15:15:24 | Yes |
| 17 | 999555 | 1492 | 3/10/2006 15:15:25 | No |
| 18 | 999555 | 1941 | 3/10/2006 15:16:00 | No |
| 19 | 999555 | 1776 | 3/10/2006 15:16:35 | No |
| 20 | 999555 | 1984 | 3/11/2006 7:15:25 | Yes |
| 21 | 999555 | 222333 | 3/11/2006 15:13:54 | Yes |
| 22 | 999555 | 222333 | 3/12/2006 15:14:08 | Yes |
| 23 | 999555 | 6345789 | 3/12/2006 20:44:25 | Yes |
| 24 | 999555 | 222333 | 3/13/2006 15:10:31 | Yes |
| 25 | 999555 | 222333 | 3/14/2006 0:00:00 | Yes |
| 26 | 999555 | 6345789 | 3/28/2006 15:15:22 | Yes |
| 27 | 1000580 | 11058183 | 3/18/2006 17:55:22 | Yes |
| 28 | 1001580 | Null | 3/18/2006 19:55:22 | Yes |
| 29 | 1001605 | 16051213 | 3/16/2006 18:10:46 | Yes |
| 30 | 1002630 | 18783900 | 3/15/2006 14:57:00 | Yes |
| 31 | 1003655 | 3862582 | 3/21/2006 23:35:05 | Yes |
| 32 | 1004680 | 6006172 | 3/15/2006 2:16:21 | Yes |
| 33 | 1005705 | RFID-12016954 | 3/29/2006 19:35:48 | Yes |
| 34 | 1006730 | 9066030 | 3/27/2006 21:15:56 | Yes |
| 35 | 1007755 | 7425552 | 3/26/2006 19:18:22 | Yes |

In this line 1 example, we will assume that this access point is for a secure delivery storage appliance. The unique EID for this particular appliance is “894915”. A person entered the code “10546403” at 3:09 PM on Mar. 21, 2006. The system confirmed this as a valid code for this access point and additionally validated the date, time and recurrence limitations for the use of this code at this time and place and thus allowed access denoted by the “Yes” field in that record.

Line 6 through line 26 shows a range of activity at access point “999555”. The range of activity is Mar. 1, 2006 through Mar. 28, 2006. The activity shows a variety of codes used and the date and time of each use. Note lines 17 through 19. In this example, an unauthorized user attempted to access the unit by entering familiar dates as access codes. In these three attempts, the system denied access as denoted by the “No” field in those three records.

Also note the data record in line 28. In this example, the locking mechanism was opened even though no code was entered at the access point. In this case, the system tracked the occurrence of a single opening of an access point without the need of a valid code. This situation is applicable where the User wants to track usage at an unsecured Delivery Appliance such as an information kiosk at a public place.

Additionally, note the data record in line 33 of Table 1. This field shows an occasion where the locking mechanism was opened by the use of an authorized Auto-ID method such as RFID or other similar electronic method, as opposed to a manually entered code.

Table 2 shows the data table for a single Device with the unique EID of “999555” shown on line 2. Line 3 has text showing the location of this Device. Line 6, 7 & 8 shows that there are three Members for this Device. This would be the case with three building tenants with a common Delivery Appliance. Lines 9 through 23 show a list of unique authorized codes associated with the respective Member who has permission to manage that unique code.

TABLE 2
Table 2 - Access
Point Data
Record

| Line # | | | |
|---|---|---|---|
| 1 | | | |
| 2 | Device EID | 999555 | |
| 3 | Device Location | 75205 | 921 E Commerce |
| | | | Street, Dallas, Texas |
| | | | 75205, SW Corner of |
| | | | the front porch |
| 4 | | | |
| 5 | Authorized Member ID | | |
| 6 | Member ID | 8884 | |
| 7 | Member ID | 56879 | |
| 8 | Member ID | 77795 | |
| 9 | | Authorized | Unique Codes |
| | | Member ID | |
| 10 | | 8884 | 1984 |
| 11 | | 56879 | 2133 |
| 12 | | 8884 | 3006 |
| 13 | | 56879 | 3155 |
| 14 | | 8884 | 222333 |
| 15 | | 56879 | 222482 |
| 16 | | 8884 | 852485 |
| 17 | | 56879 | 852634 |
| 18 | | 8884 | 5875125 |
| 19 | | 77795 | 5875274 |
| 20 | | 8884 | 6345789 |
| 21 | | 56879 | 6345938 |
| 22 | | 8884 | 6758504 |
| 23 | | 77795 | 6758653 |

Table 3 shows the data associated with a particular Member. Line 2 is the unique Member ID # for this Member. Lines 3 through 14 show the contact and billing information for this Member. Line 16 shows one Device EID associated with this Member. Lines 18 through 24 shows unique Authorized Codes associated with this Member and Device EID combination. Note that this Member could have multiple Device EID and associated unique Authorized Code combinations but only one set is illustrated here.

TABLE 3
Table 3 - Member Data
Record

| Line # | | |
|---|---|---|
| 1 | | |
| 2 | Member ID | 8884 |
| 3 | Name | John Q. Smith |
| 4 | Address 1 | 123 Main Street |
| 5 | Address 2 | Suite 201 |
| 6 | City | Dallas |
| 7 | State | TX |
| 8 | Zip | 75209 |
| 9 | Country | USA |
| 10 | Phone Number 1 | 214-520-8989 |
| 11 | Phone Number 2 | 214-750-4512 |
| 12 | Mobile Phone | 972-288-4305 |
| 13 | Email 1 | JohnQ@MailServ.com |
| 14 | Email 2 | JQS3006@POPMail.com |
| 15 | | |
| 16 | Device EID | 999555 |
| 17 | | Authorized Codes |
| 18 | Me | 3006 |
| 19 | Housekeeper | 6345789 |
| 20 | Billy the Painter | 1984 |
| 21 | Paper Boy | 222333 |
| 22 | Pool Service | 852485 |
| 23 | Fed-Ex package | 5875125 |
| | 80199978522485565 | |
| 24 | Pizza Delivery | 6758504 |

Each Member ID, Device EID and Authorized Code combination will have applicable time, date and recurrence limitations associated with it. Table 4 illustrates the first hierarchy of the range of recurrence for a unique code combination. In this Table, all data records are associated with the Table 4 Device EID #999555 for Member #8884.

TABLE 4
Table 4 - Range of Reccurance

| | | | Start | End | Lock Open | | | | |
|---|---|---|---|---|---|---|---|---|---|
| Line # | Start Date | End Date | Time | Time | Duration | Reccurances | Used | Remaining | Code |
| 1 | | | | | | | | | |
| 2 | any | any | any | any | 10 Seconds | any | any | any | 3006 |
| 3 | 1-Jan-06 | 31-Dec-06 | 7:30 AM | 5:30 PM | 10 Seconds | any | any | any | 6345789 |
| 4 | 15-Mar-06 | 15-Apr-06 | 9:00 AM | 6:00 PM | 10 Seconds | any | any | any | 1984 |
| 5 | 15-Feb-04 | any | 6:00 AM | 8:00 AM | 10 Seconds | any | any | any | 222333 |
| 6 | any | any | any | any | 8 Hours | 52 | 13 | 39 | 852485 |
| 7 | any | any | any | any | 10 Seconds | 1 | 0 | 1 | 5875125 |
| 8 | Today Only | Today Only | any | 8:15 PM | 10 Seconds | 1 | 1 | 0 | 6758504 |

Line 2 shows a data record that would likely be set up for the Member only. In this example, “any” range of dates is authorized, for “any” time of day and with “any” number of occurrences of usage. In other words, Code 3006 is used by the owner and there are no limitations on that code's usage.

Line 3 shows a code “6345789” that is assigned to the “Housekeeper” from Table 3 above. This code is valid only during the calendar year 2006, and only from 7:30 am to 5:30 pm. Upon use, the lock will stay open for 10 seconds. There is no limit to the number of occurrences of use.

Line 4 shows a code “1984” that is assigned to the “Billy the Painter” from Table 3 above. This code is valid only during from Mar. 15, 2006 through Apr. 15, 2006 and only from 9:00 am to 6:00 pm. Upon use, the lock will stay open for 10 seconds. Again, there is no limit to the number of occurrences of use during this timeframe.

The “Paperboy” #222333 is given access beginning on Feb. 15, 2004 with no termination date but only from 6:00 am to 8:00 am.

The “Pool service” #852485 is given access for 8 hours for any period of time they show up but this is limited to 52 visits of which they have used 13 and have 39 remaining.

Fed-Ex package 80199978522485565 has an access code #5875125 which is valid at any time for a one time use only.

The Pizza delivery code #6758504 is good for a one time use, today only, with no start time but terminating at 8:15 pm if Speedy Luigi's don't deliver the pepperoni with anchovies by then.

Table 5 shows optional recurrence patterns that can additionally be associated with each code from table 4. In this way, each code has a valid range of time or recurrence from table 4 and may further have a recurrence pattern valid only on certain days, dates, weeks, months or years.

TABLE 5
Table 5 - Optional
Reccurance patterns

| Line # | |
|---|---|
| 1 | Daily |
| 2 | Every # days |
| 3 | 1 |
| 4 | 2 |
| 5 | |
| 6 | (or) |
| 7 | |
| 8 | Every Weekday |
| 9 | Yes |
| 10 | No |
| 11 | |
| 12 | (or) |
| 13 | |
| 14 | Every Saturday & |
| | Sunday |
| 15 | Yes |
| 16 | No |
| 17 | |

| 18 | (or) | | | | | | | |
|---|---|---|---|---|---|---|---|---|
| 19 | | | | | | | | |
| 20 | Weekly | | | | | | | |
| 21 | Recur | | | | | | | |
| | Every # | | | | | | | |
| | Weeks | Sun | Mon | Tues | Wed | Thurs | Fri | Sat |
| 22 | 1 | No | Yes | Yes | Yes | Yes | Yes | No |
| 23 | 2 | No | Yes | No | Yes | No | Yes | No |
| 24 | | | | | | | | |

| 25 | (or) | |
|---|---|---|
| 26 | | |
| 27 | Monthly By Date | |
| 28 | Day | Every # Month(s) |
| 29 | 20th | 2 |
| 30 | 15th | 1 |
| 31 | 30th | 1 |
| 32 | | |
| 33 | (or) | |
| 34 | | |

| 35 | Monthly by Day | | |
|---|---|---|---|
| 36 | | | of every # |
| | the # | Day | Month |
| 37 | 3rd | Friday | 1 |
| 38 | 1st | Monday | 1 |
| 39 | Last | Friday | 2 |
| 40 | | | |
| 41 | (or) | | |
| 42 | | | |

| | |
|---|---|
| 43 | Yearly By Date |

| | | |
|---|---|---|
| 44 | Day | of Month |
| 45 | 26th | August |
| 46 | 12th | February |
| 47 | 6th | September |
| 48 | | |
| 49 | (or) | |
| 50 | | |

| 51 | Yearly by Day | | |
|---|---|---|---|
| 52 | the # | Day | of Month |
| 53 | 3^{rd} | Friday | August |
| 54 | first | Monday | September |
| 55 | Last | Tuesday | April |

Table 5 Line 3 shows a recurrence of every day.

Table 5 Line 4 shows a recurrence of every other day.

Table 5 Line 9 shows a recurrence of every weekday only.

Table 5 Line 15 shows a recurrence of every Saturday and Sunday.

Table 5 Line 22 shows a recurrence of every week on Monday, Wednesday & Friday only.

Table 5 Line 23 shows a recurrence of every 2nd week on Monday, Wednesday & Friday only.

Table 5 Line 29 shows a recurrence of every 2^{nd} month on the 20^{th} of that month.

Table 5 Line 30 shows a recurrence of each month on the 15^{th} of the month.

Table 5 Line 31 shows a recurrence of each month on the 30^{th} of the month.

Table 5 Line 37 shows a recurrence of each month on the 3^{rd} Friday of the month.

Table 5 Line 38 shows a recurrence of each month on the 1st Monday of the month.

Table 5 Line 39 shows a recurrence of each last Friday of every 2^{nd} month.

Table 5 Line 45 shows a recurrence of once each year on the 26^{th} of August.

Table 5 Line 53 shows a recurrence of once each year on the 3^{rd} Friday of August.

Table 5 Line 54 shows a recurrence of once each year on the 1^{st} Monday of September.

Table 5 Line 54 shows a recurrence of once each year on the last Tuesday of April.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. An access point, comprising:
a storage receptacle having a cavity and an access door adapted to selectively permit access to the cavity; and
an actuator module configured to unlock the access door in response to entry of a valid access code provided thereto by a third party, further configured to compare an entered access code provided by the third party to at least one of a plurality of valid access codes established by a physically remote host via an internet connection, or wireless communication network, the valid access codes being established by a physically remote user.

2. The access point of claim 1 further including an electronic identification number (EID) enabled such that the host can access the EID.

3. The access point of claim 1 wherein the access point further includes memory configured to store the valid access codes.

4. The access point of claim 1 wherein the access point is enabled to receive a code by the third party and validate the code with the host, the actuator configured to unlock the access door upon said validation.

5. The access point of claim 1 wherein the access point includes a keypad configured to receive the entered access code from the third party.

6. The access point of claim 1 wherein the access point includes an automatic identification electronic receiver selected from the group comprising: an RFID receiver, a bar code scanner, a magnetic card reader, a biometric reader.

7. The access point of claim 1 further including an electronic switch adapted to detect the opened or closed status of the access door as an event and adapted to electronically report this event to the remote host.

8. The access point of claim 1 further including an electronic switch adapted to detect the physical presence of a delivered item in the cavity as an event and adapted to electronically report this event to the remote host.

9. The system as specified in claim 1 wherein the access point is configurable to allow access to the cavity without receiving an access code for a predetermined period.

10. The system as specified in claim 1 wherein at least one valid access code is valid for a predetermined number of uses by a third party at the access point.

11. The access point of claim 1, further comprising a communication interface adapted to receive the valid access codes from the physically remote host.

12. The access point of claim 1, wherein the communication interface is enabled to report an event to the physically remote host.

13. The access point of claim 12 wherein the event is selected from the group comprising; the presence of a delivered item in the cavity, the opening or closing of the access door, the entry of a valid access code, the entry of an invalid access code.

14. The system as specified in claim 4 wherein at least one said access code is indicative of a provider code.

15. The access point of claim 1, wherein the access door forms a watertight seal to the cavity when closed.
